(19) United States
(12) Patent Application Publication
(10) Pub. No.: US 2023/0062393 A1
(43) Pub. Date: Mar. 2, 2023

(54) Radio Access Network Congestion Response

(71) Applicant: AT&T Intellectual Property I, L.P., Atlanta, GA (US)

(72) Inventor: Azhar Khan, Norcross, GA (US)

(21) Appl. No.: 17/463,259

(22) Filed: Aug. 31, 2021

(51) Int. Cl. H04W 28/02; G06N 20/00

(52) U.S. Cl. CPC H04W 28/0284; H04W 28/0236; G06N 20/00

(57) ABSTRACT

A response that preemptively mitigates an effect of a predicted network congestion event is disclosed. A machine learning or artificial intelligence model or process (ML/AI), that can be updatable, can be used to predicting congestion. Key performance indicators can be analyzed in accord with the ML/AI to predict, infer, etc., a characteristics of a congestion event. The analysis can be performed in near-real-time, typically with delays less than one second, but generally more than 10 milliseconds. The ML/AI, or update thereto, can be determined in non-real time, typically with delays greater than one second. A prediction of a congestion event can trigger operations that cause a user equipment to suspend use of a radio access network node, generally by shifting communications to another wireless node, access point, etc. An embodiment of the disclosed subject matter can be embodied via a virtual radio access network component.

### TECHNICAL FIELD

The subject application relates to radio access networks, and more particularly, to response to congestion in radio access networks.

### BACKGROUND

Conventionally, responding to radio access network (RAN) congestion has been reactive, e.g., when a RAN has become congested, ameliorative operations can then be performed to mitigate the now existing congestion. Alternatively, camping on a RAN can be deprioritized to preferably shift communications to non-RAN devices where they may be available to a user equipment (UE), e.g., a UE can be directed to connect to an access point (AP), such as a WI-FI access point, before connecting to a cellular network, e.g., a wireless network associated with a network carrier, where such an AP is detected by the UE. This can reduce traffic via the RAN by shifting it to local APs. However, shifting to an AP where available can result in offloading UEs from a RAN to an AP even where the RAN may not actually be encumbered. A network carrier can have an interest in providing services to a UE via a wireless network RAN connection, which can be frustrated by defaulting to shifting a UE to a local AP and can also be frustrated by allowing a RAN to become bordered prior to taking action to mitigate RAN congestion.

### BRIEF DESCRIPTION OF DRAWINGS

FIG. 1 is an illustration of an example system that can enable responding to predicted RAN congestion, in accordance with aspects of the subject disclosure.

FIG. 2 is an illustration of an example system that can facilitate employing a virtual RAN component to support responding to predicted RAN congestion, in accordance with aspects of the subject disclosure.

FIG. 3 is an illustration of an example system that can enable responding to predicted RAN congestion via a near real-time component and a non-near-real-time component, in accordance with aspects of the subject disclosure.

FIG. 4 illustrates an example system that can facilitate responding to predicted RAN congestion based on determining a model via a remotely located modeling component, in accordance with aspects of the subject disclosure.

FIG. 5 is an illustration of an example system enabling responding to predicted RAN congestion supporting routing traffic via one or more of a RAN, a coupled AP, a decoupled AP, or a component bypassing a core network, in accordance with aspects of the subject disclosure.

FIG. 6 is an illustration of an example method facilitating responding to predicted RAN congestion, in accordance with aspects of the subject disclosure.

FIG. 7 illustrates an example method supporting updating a model employed in responding to predicted RAN congestion, in accordance with aspects of the subject disclosure.

FIG. 8 illustrates an example method enabling returning to a RAN after responding to predicted RAN congestion, in accordance with aspects of the subject disclosure.

FIG. 9 depicts an example schematic block diagram of a computing environment with which the disclosed subject matter can interact.

FIG. 10 illustrates an example block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As has been noted for conventional radio access networks (RANs), response to RAN congestion has generally been reactive or can default to preemptive offloading of served devices. For reactive response to RAN congestion, operations to mitigate congestion can occur after the RAN has already reached a threshold level of congestion, e.g., the response can be reactive to congestion already in existence. For preemptive offloading of devices from a RAN, automatically shifting UEs to a local AP wherever and whenever those APs become available can result in moving the UEs from a RAN than may not even be congested. While this can reduce traffic via the RAN by shifting it to local APs, it can impact an interest of a network carrier, e.g., it can impact the carrier's ability to provide services to a UE via a RAN connection where UEs are defaulting to an available local AP.

In embodiments of the disclosed subject matter, a wireless service provider, e.g., a wireless network associated with a network carrier identity, can reduce impact to a wireless service, e.g., voice, data, services, etc., of a customer that can be associated with RAN congestion, for example, RAN congestion due to an adverse event, equipment failure, peak network demand fluctuation, etc. RAN congestion can be predicted, e.g., via machine learning (ML), artificial intelligence (AI), etc., techniques to enable remediation actions to be taken proactively, rather than merely being reactive like more conventional technologies. Proactive mitigation of predicted RAN congestion can reduce, or possibly eliminate, disruption of a communication link to a UE of a customer. In embodiments, determination of a congestion condition based on ML/AI analysis key performance indicators (KPIs) for a network associated with historical RAN congestion, can be leveraged to cause a UE to employ an alternate communication link, e.g., steering a UE to switch to an AP in lieu of a RAN when the RAN is predicted to become congested. This can be distinct from some historical approaches to mitigating RAN congestion that may have included deploying new RAN equipment to increase RAN capacity, using cell splitting and drones to provide additional bandwidth, etc.

The use of ML/AI to predict traffic congestion, for example in a wireless access network like a RAN, can be applied to a virtual RAN (vRAN), for example, an Open RAN-type (O-RAN) architecture, see O-RAN ALLIANCE currently at o-ran.org. As such ML/AI can be employed to re-route wireless traffic for a mobile device through another network, such as another carrier/provider wireless network, via an AP, via an ad hoc wireless network), etc., prior to an occurrence of congestion actually occurring on a portion of a RAN, e.g., a UE served by a RAN that is predicted to experience increasing a threshold level of congestion can be steered onto other networks to better avoid the effects of expected congestion on the RAN. This proactive congestion response can implore a customer experience where service can be less likely to be disrupted due to a congestion event in the wireless network, e.g., in the RAN. It is noted that after a congestion event clears, wireless traffic can be re-routed back through the RAN as usual. Moreover, it is possible that the disclosed subject matter can be implemented within existing wireless network components, more especially where components of a wireless network are increasingly virtualized, e.g., a vRAN can readily be directed to perform aspects of the disclosed subject matter and to communicate with UEs, for example via UE applications, etc., to effect the disclosed proactive congestion response technology. This can greatly improve deployment speed and cost while providing an improved wireless network experience for end users.

The disclosed subject matter can deploy two components related to performing ML/AI analysis of a portion of a wireless network. As an example, a first component can be a congestion response control component (CRCC) can operate, typically in a non-near real-time (non-NRT) manner to develop, implement, etc., ML/AI models/technologies, hereinafter a ‘model’ for clarity and brevity, that can predict a likelihood of a congestion event occurring. The model can then be passed to a second component, that can be a congestion response monitoring component (CRMC) that can operate in a real-time (RT) or near-real-time (NRT) manner to analyze network KPIs to determine a likelihood of a congestion event occurring. The example CRMC can then communicate an indication of a predicted congestion event back to CRCC that can in turn determine likely affected UEs and direct instruction thereto that can cause the UEs to shift from the RAN to another communication link to avoid the predicted RAN congestion event. It is noted that the ML/AI technology can typically apply a ML/AI process and model that can continuously monitor and detect traffic congestion signatures in a RAN, e.g., a vRAN, etc. It is further noted that applying the ML/AL analysis in NRT is typically associated with delays of less than one second, e.g., non-NRT is typically greater than one second delay, NRT is typically between ten millisecond and one second delay, and RT is typically less than ten millisecond delay, for example, as has presently been adopted by the O-RAN reference architecture.

Accordingly, development of ML:/AI models, processes, and signaling of UEs, etc., can occur without consuming more highly valuable NRT or RT processor resources in a vRAN architecture via non-NRT use of example component CRCC, etc. Further, monitoring of a RAN can occur via fast analysis, e.g., the example CRMC can operate in NRT to analyze network KPIs promptly to enable a meaningful prediction of a congestion event probability. It is noted that implementation of the ML/AI model, process, etc., in NRT, RT, etc., can be based on development of that ML/AI model, process, etc., in a non-NRT, e.g., slow, component. This strips down the operations performed at in the NRT regime to those needed for the analysis while also relegating operations not needed for the analysis to a non-NRT regime component. In embodiments, steering away from a RAN due to a prediction of a congestion event can comprise directing a UE to switch to an AP, for example a WI-FI AP, etc. In some embodiments, an AP can be affiliated with the wireless carrier, for example, AT&T can direct a UE to switch from an AT&T RAN to an ATTWiFi AP. In some embodiments, other APs can also be selects, e.g., switching to another carrier WI-FI, other carrier RAN, etc. In some embodiments, alternate network links can be ranked, ordered, etc., for example by carrier identity, performance metrics, cost, existing mutuality agreements, etc., for example, switching from a RAN can prefer an ATTWiFi AP, then a non-AT&T WI-FI AP.

In embodiments, returning UEs to the carrier's RAN can be desirable. As such, determining that a congestion event has passed, e.g., the RAN in not congested, is not predicted to become contemporaneously congested, etc., an indication can be sent to UEs indicating that they should switch back the RAN. In some embodiments, a selectable delay can be employed by UEs, for example, switching from a RAN to an AP can trigger a clock that can cause the UE to check to see if it is permitted to return to the RAN. In these embodiments, the time can be a default delay, a selected delay, etc., e.g., the indication to switch away from the RAN can include a delay time that can be used by a UE to determine when the UE should check to see if it can return to the RAN. In other embodiments, the UE can wait for further instructions tot return to the RAN. Moreover, where the UE leaves the area served by a RAN and/or AP, then upon returning to the area served by the RAN/AP, the UE can either recheck to see if it can join the RAN, e.g., the congestion event has passed, can continue to rely on a default, selected, or indicated delay time, or can return to the AP unless it has received an indication that the RAN is again available.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

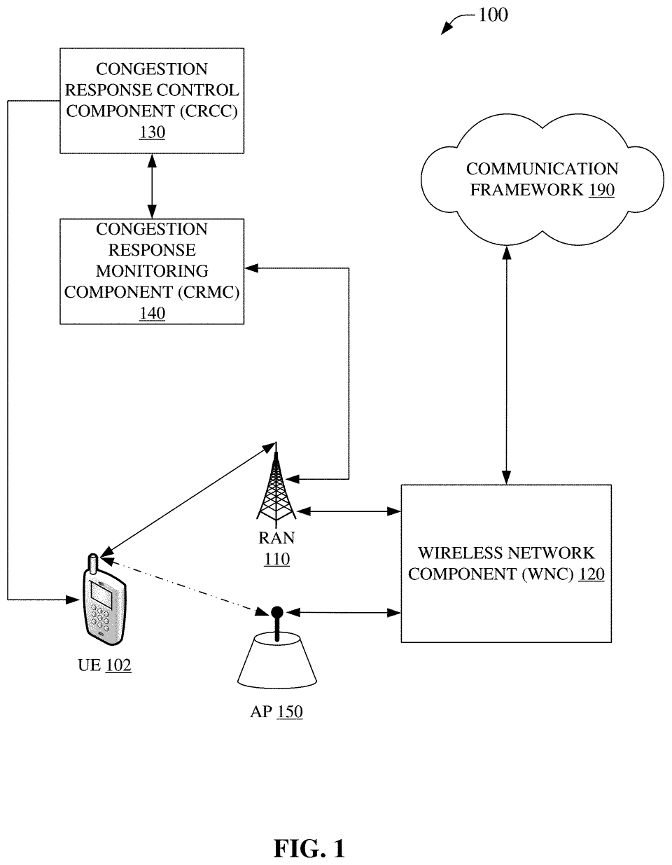

FIG. 1 is an illustration of a system 100, which can facilitate responding to predicted RAN congestion, in accordance with aspects of the subject disclosure. System 100 can comprise user equipment (UE) 102 that can be connected to a wireless network component (WNC) 120 that is associated with a wireless network provider, which can also be referred to as a carrier, etc., via a radio access network component (RAN) 110. WNC 120 can connect to other networks, devices, components, servers, etc., e.g., UE 102 can reach an internet server via RAN 110, WNC 120, and communication framework 190. System 100 can further comprise access point (AP) 150 that can be coupled to WNC 120. As an example, AP 150 can be a WI-FI AP that can connect UE 102 to WNC 120 to facilitate communication between UE 102 and other devices, components, etc., through communication framework 190, e.g., UE 102 can reach an internet server via AP 150, WNC 120, and communication framework 190.

System 100 can comprise congestion response control component (CRCC) 130 and congestion response monitoring component (CRMC) 140. CRCC 130 and CRMC 140 can be communicatively coupled in a 1:1 configuration. In embodiments, there can be multiple instances of CRCC 130 and CRMC 140, as examples, a first CRCC 130 can be connected to a plurality of CRMCs 140 in a 1:N configuration; a first CRMC 140 can be connected to a plurality of CRCCs 130 in an M:1 configuration; a plurality of CRCCs 130 can be connected to a plurality of CRMCs 140 in an M:N configuration. Connections between CRCC 130 instances and CRMC 140 instances can be via nearly any communications modality, e.g., direct connection(s), via communication framework 190, etc., or combinations thereof. In an example embodiment, a first geographic region can have wireless coverage associated with a coverage area of RAN 110. In this example, a second geographic region can also have coverage from RAN 110, e.g., RAN 110 can cover portions of one or more geographic areas. In this example, a first instance of CRMC 140 can monitor RAN 110 in relation to the first geographic area and a second instance of CRMC 140 can monitor RAN 110 in relation to the second geographic area. In this example, congestion modeling of RAN 110, e.g., ML/AI models and processes for RAN 110 can be developed by a first instance of CRCC 130 for each of the first and second geographic areas. As such, in this example, the first instance of CRCC 130 can provide a first ML/AI model to the first instance of CRMC 140 and a second ML/AI model to the second instance of CRMC 140, e.g., the CRCC/CRMC instances can have a 1:N configuration in this example. Accordingly, for this example, the first instance of CRMC 140 can be configured to monitor RAN 110 in relation to the first geographic area and the second instance of CRMC 140 can be configured to monitor RAN 110 in relation to the second geographic area. Other examples, e.g., 1:1, M:1, 1:N, M:N, etc., CRCC/CRMC instance(s) configuration(s), will be readily appreciated by one of ordinary skill in the art and are considered within the scope of the instant disclosure even where not recited for the sake of clarity and brevity.

In system 100, CRMC 140 can monitor wireless network KPIs in relation to predicting, inferring, etc., a likelihood of a congestion event, e.g., a threshold level of congestion, etc., at RAN 110. CRMC 140 can employ a ML/AI process(es) and model(s), e.g., some combination of processes and models, such as a process, a model, both a process and a model, more than one process and/or more than one model, etc., to determine an occurrence of a threshold level of network congestion. It is note that the congestion can occur anywhere in the network, but that typically the congestion being responded to is between WNC 120 and UE 102, e.g., communications traversing RAN 110. As such, in response to predicting a congestion event, steering communications to links that exclude RAN 110 can typically avoid impacts of the congestion event to communications between UE 102 and WNC 120. It is noted that the act of steering traffic away from RAN 110 itself can mitigate the occurrence of the predicted congestion event, e.g., RAN 110 can avoid experiencing a congestion event by offloading communications from RAN 110. It is further noted that the predicted congestion event can still occur despite steering traffic away from RAN 110, however, a UE that has changes from RAN 110 to AP 150 can typically avoid effects of a congestion event affecting RAN 110. In some embodiments, a predicted, inferred, etc., network congestion event can relate to network circumstances beyond the connection between UE 102 and WNC 120, e.g., a core network component can experience a failure, high latency can occur in communication framework 190, etc. In these embodiments, CRMC 140 can still infer, predict, etc., a likelihood of a congestion event. Moreover, in these embodiments, rerouting of UE 102 from RAN 110 to AP 150 for example, can be more similar to rerouting UE 502 in system 500 to decoupled AP 554 that can bypass WNC 520 in an attempt to avoid impacts of the predicted congestion event.

CRMC 140 can indicate to CRCC 130 a likelihood of a congestion event. In embodiments, the indication can be a value of the likelihood, while in other embodiments, the indication can be more primal and indicate a binary value, e.g., yes/no, I/O, etc. As such, CNCC 130 can employ the indicated likelihood in determining signaling to UE 102. As an example, in response to CRMC 140 indicating a high probability of an upcoming congestion event, CNCC 130 can generate a signal that can indicate to UE 102 that it should route communications, e.g., data, voice, or combinations thereof, via AP 150 in lieu of RAN 110. It is readily appreciated by one of ordinary skill in the art that data and voice communications can be differently impacted by network congestion and thus can be controlled for separately, however for the sake of clarity and brevity, discussion of rerouting, steering, offloading, etc., communications should be considered to apply to voice, data, or combinations thereof. As an example, where voice traffic is managed by a circuit switched (CS) connection to RAN 110, network congestion may not affect CS traffic and UE 102 can continue to route CS traffic via RAN 110 even where packetized data communication can be rerouted via AP 150 in this example. In another example, where voice and data are both packetized, network congestion can cause rerouting of both voice and data from UE 110 to AP 150. Other examples are not recited for the sake of clarity and brevity but are to be considered within the scope of the instant disclosure.

CRCC 130 can operate in a non-near real-time (non-NRT) regime, e.g., delays of greater than about a one second are acceptable in an example O-RAN reference architecture. In contrast, CRMC 140 can typically operate in a near real-time (NRT) regime, e.g., with delays typically being between ten milliseconds and one second, although in some embodiments CRMC 140 can operate in a real-time (RT) regime with delays typically under ten milliseconds. It is generally appreciated that RT and NRT operations are relegated to higher priority operations than non-NRT operations, although with limited computing resources, there is generally a greater limitation on how many operations can be performed in NRT and even fewer operations can typically be performed in RT. Accordingly, CRCC 130 and CRMC 140 can operate in different time regimes to provide prompt indication of a predicted, inferred, likelihood of a congestion event at CRMC 140 and then less prompt mitigation via CRCC 130 indicating shedding UE 102 from RAN 110. As an example, CRMC 140 can perform a congestion analysis every 20 milliseconds (ms), e.g., 50 times per second, and CRCC 130 can receive corresponding indications from CRMC 140 and can then generate a signal to UE 102 after three seconds. In this example, the three second delay can provide time to determine which UEs can be affected, which UEs should be shed to mitigate the effects of a sufficiently likely congestion event, determining possible suggested rerouting information for selected UEs, etc., such that, in this example, based on the prompt determination of a likely congestion event occurring, a number of UEs can be instructed to attempt to reroute traffic via a selected and indicated AP 150 for a determine period, such as ten minutes, etc. As can be observed in this example, CRMC 140 is only burdened with the NRT congestion analysis, while other determinations are shifted to CRCC 130 that can operation in a non-NRT regime.

CRCC 130 can further be employed to monitor network conditions and to develop, improve, etc., ML/AI model(s), process(es), etc. In this regard, the non-NRT regime operations can be directed to better predicting possible congestion events, e.g., more accurate determining a likelihood of a congestion event, more efficiently determining a likelihood of a congestion event, etc. This then does not burden processes and operations in the NRT or RT regime, as might otherwise occur where CRCC 130 and CRMC 140 are more directly competing for resources, e.g., a single component performing all functionality of a CRCC/CRMC. As an example, CRCC 130 can determine an improved ML/AI process that can infer, predict, determine, etc., a likelihood of a congestion event occurring 15% more accurately and with 75% of the operations of a previous iteration of the ML/AI process, e.g., the improved process is both more accurate and more efficient in this example. The example improved process can then be communicated from CRCC 130 to CRMC 140 to be implemented in the NRT regime to monitor network KPIs to predict, infer, etc., a likelihood of network congestion. Where a congestion event is predicted by CRMC 140, this can be indicated to CRCC 130 that can then determine signaling to UE 102 that can cause UE 102 to reroute communication through AP 150 in lieu of RAN 110.

In embodiments, CRCC 130 can further indicate to UE 102 a time that to stay off RAN 110. In embodiments, the time can be a default time, a determined time, such as can be determined based on the KPIs and predicted congestion event, or an indefinite time, e.g., until notified RAN 110 is again available to UE 102, etc. As a first example, CRCC 130 can indicate that UE 102 should avoid RAN 110 until UE 102 is notified that RAN 110 is again available for use. In a second example, CRCC 130 can indicate that UE 102 should check every five minutes to see if RAN 110 is available for use. In a third example, CRCC 130 can indicate that UE 102 should reconnect to RAN 110 after sixty seconds, after which, CRCC 130 can again determine if UE 102 should be shed from RAN 110. In a fourth example, CRCC 130 can avoid indicating a time and allow UE 102 to employ a time determined local to UE 102. In embodiments, CRCC 130 can receive an indication that a congestion event has passed, e.g., CRCC 130 can determine resolution of a congestion event by monitoring network KPIs, CRCC 130 can receive an indication from CRMC 140 based on CRMC 140 determining that the congestion event has concluded, etc. In these embodiments, CRCC 130 can indicate to UE 102 that RAN 110 is again available for communication. In some embodiments, CRCC 130 can direct UE 102 to reconnect to RAN 110, e.g., actively triggering UE 102 to reconnect to RAN 110 rather than more passively waiting for UE to reconnect to RAN 110 once it become available.

In system 100, CRCC 130 can be located local to, or remotely from, CRMC 140. In an embodiment, CRCC 130 and CRMC 140 can be located in WNC 120 device or some component thereof. However, CRCC 130 and CRMC 1540 are not limited to placement at a WNC 120 and, in some embodiments, can be located in RAN 110, another remotely located component that is not illustrated, in a component of another RAN that is not illustrated, or other locations. As an example, CRCC 130 can be located in a core component of a network associated with a carrier. CRCC 130 can communicate to a plurality of CRMC 140 each located in a RAN component, for example a gNodeB (gNB), etc. In embodiments, UE 102 can comprise a component to facilitate communication with CRCC 130, e.g., an application can run on UE 102 that can cause UE 102 to switch from RAN 110 to another AP, another RAN, etc., when the example application receives a corresponding indication form CRCC 130 and, as such, the application can specifically provide for implementation of the switching of UE 102 away from RAN 110. In some embodiment, the functionality of the aforementioned example application can be embodied natively in UE 102, an operating system of UE 102, etc.

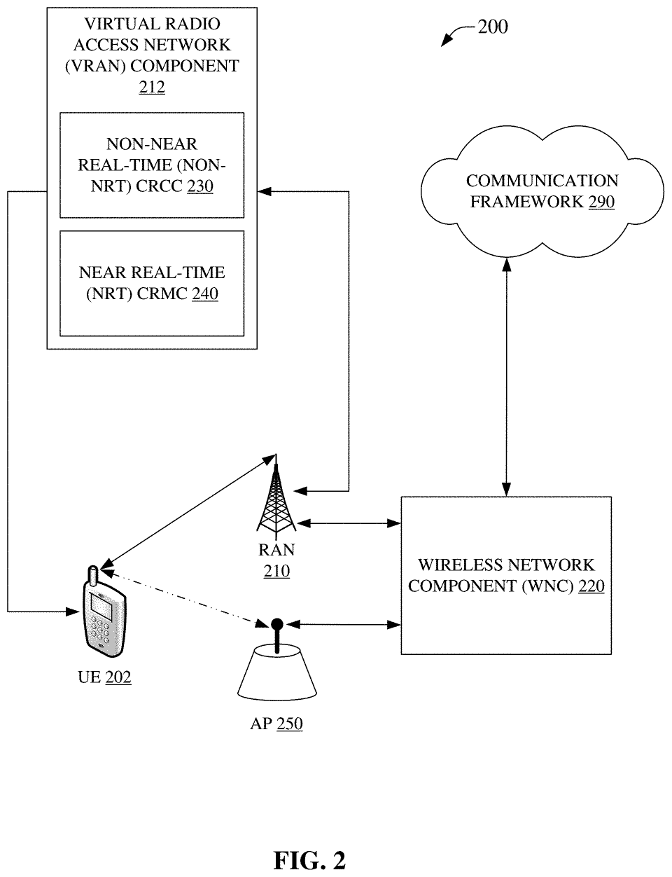

FIG. 2 is an illustration of a system 200, which can enable employing a virtual RAN component to support responding to predicted RAN congestion, in accordance with aspects of the subject disclosure. System 200 can comprise UE 202 that can be connected to a WNC 220 that is associated with a wireless network provider via RAN 210. WNC 220 can connect to other networks, devices, components, servers, etc., for example, UE 202 can communicate with internet server via RAN 210, WNC 220, and communication framework 290. System 200 can further comprise AP 250 that can be coupled to WNC 220. As an example, AP 250 can be a WI-FI AP that can connect UE 202 to WNC 220 to facilitate communication between UE 202 and other devices, components, etc., through communication framework 290, e.g., UE 202 can reach an internet server via AP 250, WNC 220, and communication framework 290.

System 200 can comprise non-NRT CRCC 230 and NRT CRMC 240. It is noted that non-NRT CRCC 230 can be the same as, or similar to CRCC 130, and can explicitly operate in a non-NRT regime. Similarly, NRT CRMC 240 can be the same as, or similar to CRMC 140, and can explicitly operate in the NRT regime. Accordingly, for clarity and brevity, non-NRT CRCC 230 is hereinafter typically referred to simply as CRCC 230, and similarly, NRT CRMC 240 is typically referred to simply as CRMC 240. CRCC 230 and CRMC 240 can be communicatively coupled. In embodiments, virtual radio access network (vRAN) component 212 can comprise CRCC 230 and CRMC 240. A vRAN can be, for example, embodied in an O-RAN reference architecture open RAN. A vRAN can be in accord with an interoperability standard for RAN elements such as non-proprietary white box hardware and software from different vendors. Network operators, e.g., carriers, providers, etc., that opt for RAN elements with standard interfaces can avoid being locked into a limited number of proprietary hardware and/or software components by employing vRAN technology. A vRAN according to a specific standard may not inherently be open source, e.g., the O-RAN standards instead aim to undo the conventional siloed nature of the RAN market, where a handful of RAN vendors only offer equipment and software that is totally proprietary, however O-RAN may itself have some proprietary aspects, albeit generally significantly less restrictive than a traditional RAN vendor. Another example vRAN organization can be the Telecom Infra Project (TIP) that can have different open standards than, for example, the O-RAN ALLIANCE. It is noted that CRCC 230 and CRMC 240 can be embodied in a vRAN that is based on nearly any selected vRAN standard, e.g., an O-RAN-type vRAN 212 can be deployed according to the O-RAN standards, a TIP-type vRAN 212 can be deployed according to the TIP standard, etc. Generally, the virtual RAN standards being developed support features such as network malleability, improved security, and reduced capex and opex costs. Using, for example, the O-RAN standard, vRAN 212 can comprise a non-RT radio intelligent controller (RIC) and a NRT RIC. In this regard, for this example, CRCC 230 can be comprised in the non-RT RIC, while the CRMC 240 can be comprised in the NRT RIC.

In system 200, vRAN 212 can monitor wireless network KPIs, which can enable CRMC 240 access to network KPIs to facilitate predicting, inferring, etc., a likelihood of a congestion event, e.g., a threshold level of congestion, etc., at RAN 210. CRMC 240 can employ a ML/AI process(es), model(s), or combination thereof, to determine an occurrence of a threshold level of network congestion. It is noted that the congestion can occur anywhere in the network but shedding UEs from an affected RAN can mitigate the impact of a congestion event on a customer experience, e.g., steering UE 202 away from RAN 210 where a congestion event is predicted to occur can typically mitigate or avoid the congestion event affecting communications between UE 202 and WNC 220. It is noted that the act of steering traffic away from RAN 210 itself can mitigate the occurrence of the predicted congestion event, e.g., a predicted congestion event may not even occur where offloading communications from the network, e.g., away from RAN 210, etc., is effective at alleviating a factor(s) that can be contributing to building network congestion. It is further noted that the predicted congestion event can still occur despite steering traffic away from RAN 210, however, a UE that has changed from RAN 210 to AP 250 can typically avoid effects of a congestion event affecting RAN 210. In some embodiments, a predicted, inferred, etc., network congestion event can relate to network circumstances beyond the connection between UE 202 and WNC 220, e.g., a core network component can experience a failure, high latency can occur in communication framework 290, etc. In these embodiments, CRMC 240 can still infer, predict, etc., a likelihood of a congestion event. Moreover, in these embodiments, rerouting of UE 202 from RAN 210 to AP 250 for example, can be more similar to rerouting UE 502 in system 500 to decoupled AP 554 that can bypass WNC 520 in an attempt to avoid impacts of the predicted congestion event.

CRMC 240 can indicate to CRCC 230 a likelihood of a congestion event. As such, CNCC 230 can employ the indicated likelihood in determining signaling to UE 202. As an example, in response to CRMC 240 indicating a high probability of an upcoming congestion event, CNCC 230 can generate a signal that can indicate to UE 202 that it should route communications, e.g., data, voice, or combinations thereof, via AP 250 in lieu of RAN 210. Whereas non-NRT CRCC 230 can operate in a non-near real-time regime, and NRT CRMC 240 can operate in a near real-time regime, and where is understood that NRT operations are typically higher priority operations than non-NRT operations, separating the operation of non-NRT CRCC 230 to a non-RT RIC can be understood to shift processing burdens away from a NRT RIC, e.g., the operations of NRT CRMC 240 are pared down to reduce the burden on a NRT RIC and more extraneous operations, functionality, etc., are shifted from NRT CRMC 240 to non-NRT CRCC 230. As such, the operations, functionality, etc., of non-NRT CRCC 230 can be broader than might be more typically found in a component attempting to perform operations on a NRT RIC. As an example, CRCC 230 can enable analysis of which UEs of a system can be affected, enable selecting a portion of affected UEs to shed that can best mitigate the predicted, inferred, etc., congestion event, determine a reconnect time, or many other functions whose performance on a NRT RIC would generally be considered wasteful or expensive in terms of computing resource consumption. As such, example embodiments can endeavor to minimally burden NRT CRMC 240, for example, by limiting operation to only a network congestion analysis based on a model, process, etc., determined at another component, e.g., at non-NRT CRCC 230 that can operation in a non-NRT regime.

CRCC 230 can further be employed to monitor network conditions and to develop, improve, etc., ML/AI model(s), process(es), etc. In this regard, the non-NRT regime operations can be directed to better predicting possible congestion events, e.g., more accurate determining a likelihood of a congestion event, more efficiently determining a likelihood of a congestion event, etc. This then does not burden processes and operations in the NRT or RT regime. Where a congestion event is predicted by CRMC 240, this can be indicated to CRCC 230 that can then determine signaling to UE 202 that can cause UE 202 to reroute communication through AP 250 in lieu of RAN 210. In embodiments, CRCC 230 can further indicate to UE 202 a time that to stay off RAN 210, e.g., a reconnect time, delay, etc. In embodiments, the time can be a default time, a determined time, such as can be determined based on the KPIs and predicted congestion event, an indefinite time, or other times, delays, etc. In embodiments, CRCC 230 can receive an indication that a congestion event has passed, e.g., CRCC 230 can determine resolution of a congestion event by monitoring network KPIs, CRCC 230 can receive an indication from CRMC 240 based on CRMC 240 determining that the congestion event has concluded, etc. In these embodiments, CRCC 230 can indicate to UE 202 that RAN 210 is again available for communication. In some embodiments, CRCC 230 can direct UE 202 to reconnect to RAN 210, e.g., actively triggering UE 202 to reconnect to RAN 210 rather than more passively waiting for UE to reconnect to RAN 210 once it become available.

In system 200, CRCC 230 can be located local to, or remotely from, CRMC 240, e.g., vRAN can be comprised of locally and/or remotely located components. In an embodiment, CRCC 230 and CRMC 240 can be located in WNC 220 device or some component thereof. However, CRCC 230 and CRMC 240 are not limited to placement at a WNC 220. In embodiments, UE 202 can comprise a component to facilitate communication with CRCC 230, e.g., an application can run on UE 202 that can cause UE 202 to switch from RAN 210 to another AP, another RAN, etc. In some embodiment, the functionality of UE 202 to communicate with CRCC 230 can be embodied natively in UE 202 hardware, software, or combinations thereof.

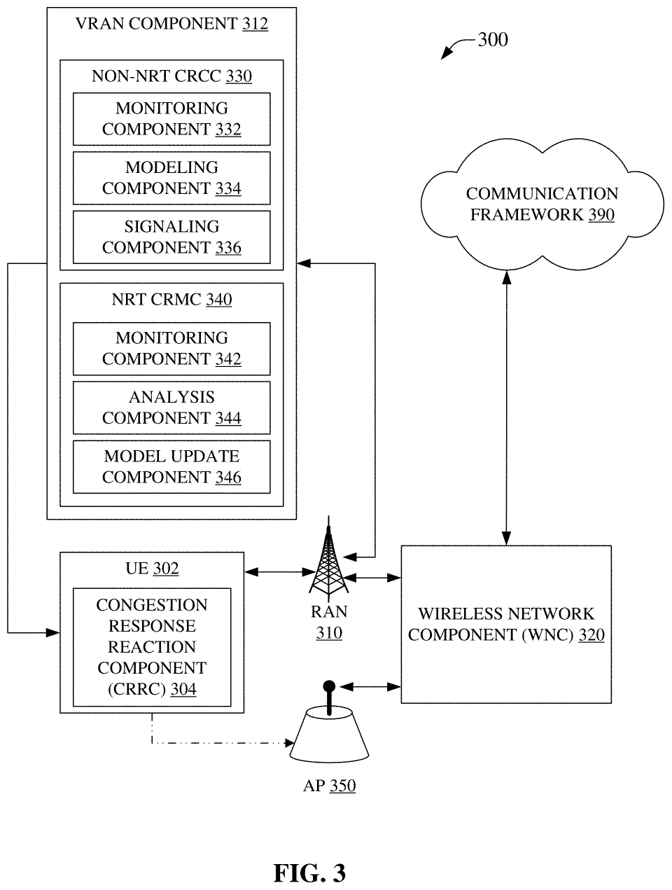

FIG. 3 is an illustration of a system 300 that can facilitate responding to predicted RAN congestion via a near real-time component and a non-near-real-time component, in accordance with aspects of the subject disclosure. System 300 can comprise UE 302 that can be connected to a WNC 320 that is associated with a wireless network provider via RAN 310. WNC 320 can connect to other networks, devices, components, servers, etc., for example, UE 302 can communicate with internet server via RAN 310, WNC 320, and communication framework 390. System 300 can further comprise AP 350 that can be coupled to WNC 320. As an example, AP 350 can be a WI-FI AP that can connect UE 302 to WNC 320 to facilitate communication between UE 302 and other devices, components, etc., through communication framework 390, e.g., UE 302 can reach an internet server via AP 350, WNC 320, and communication framework 390.

System 300 can comprise non-NRT CRCC 330 and NRT CRMC 340. It is noted that non-NRT CRCC 330 can be the same as, or similar to CRCC 130, and can explicitly operate in a non-NRT regime. Similarly, NRT CRMC 340 can be the same as, or similar to CRMC 140, and can explicitly operate in the NRT regime. Accordingly, for clarity and brevity, non-NRT CRCC 330 is hereinafter typically referred to simply as CRCC 330, and similarly, NRT CRMC 340 is typically referred to simply as CRMC 340. CRCC 330 and CRMC 340 can be communicatively coupled. In embodiments, virtual radio access network (vRAN) component 312 can comprise CRCC 330 and CRMC 340. A vRAN can be, for example, embodied in an O-RAN reference architecture open RAN. It is noted that CRCC 330 and CRMC 340 can be embodied in a vRAN that is based on nearly any selected vRAN standard, e.g., an O-RAN-type vRAN 312 can be deployed according to the O-RAN standards, a TIP-type vRAN 312 can be deployed according to the TIP standard, etc. Generally, the virtual RAN standards being developed support features such as network malleability, improved security, and reduced capex and opex costs. Using, for example, the O-RAN standard, vRAN 312 can comprise a non-RT radio intelligent controller (RIC) and a NRT RIC. In this regard, for this example, CRCC 330 can be comprised in the non-RT RIC, while the CRMC 340 can be comprised in the NRT RIC.

In system 300, vRAN 312 can monitor wireless network KPIs, which can enable CRMC 340 access to network KPIs, e.g., via monitoring component 342, to facilitate predicting, inferring, etc., a likelihood of a congestion event, e.g., a threshold level of congestion, etc., at RAN 310. CRMC 340 can employ a ML/AI process(es), model(s), or combination thereof, via analysis component 344, to predict, infer, determine, etc., an occurrence of a threshold level of network congestion, e.g., analysis component 344 can predict a likelihood of a congestion event based on model(s), process(es), or combinations thereof, and monitored KPIs for a portion of a network. Model update component 346 can be employed to receive an updated model, process, etc., e.g., model update component 346 can receive an updated model from CRCC 330, such as can be determined, generated, etc., by modeling component 334. It is noted that the congestion can occur in any portion of a network and shedding UEs from a RAN expected to be affected by a predicted, inferred, etc., congestion event can mitigate the impact of a congestion event on a customer experience, e.g., steering UE 302 away from RAN 310 where a congestion event is predicted to occur can typically mitigate or avoid the congestion event affecting communications between UE 302 and WNC 320. It is noted that the act of steering traffic away from RAN 310 itself can mitigate the occurrence of the predicted congestion event, e.g., a predicted congestion event may not even occur where offloading communications from the network, e.g., away from RAN 310, etc., is effective at alleviating a factor(s) that can be contributing to building network congestion. It is further noted that the predicted congestion event can still occur despite steering traffic away from RAN 310, however, a UE that has changed from RAN 310 to AP 350 can typically avoid effects of a congestion event affecting RAN 310. In some embodiments, a predicted, inferred, etc., network congestion event can relate to network circumstances beyond the connection between UE 302 and WNC 320, e.g., a core network component can experience a failure, high latency can occur in communication framework 390, etc. In these embodiments, CRMC 340 can still infer, predict, etc., a likelihood of a congestion event. Moreover, in these embodiments, rerouting of UE 302 from RAN 310 to AP 350 for example, can be more similar to rerouting UE 502 in system 500 to decoupled AP 554 that can bypass WNC 520 in an attempt to avoid impacts of the predicted congestion event.

CRMC 340 can indicate to CRCC 330 a likelihood of a congestion event. As such, CNCC 330 can employ the indicated likelihood in determining signaling to UE 302. As an example, in response to CRMC 340 indicating a high probability of an upcoming congestion event, signaling component 336 of CNCC 330 can generate a signal that can indicate to UE 302 that it should route communications, e.g., data, voice, or combinations thereof, via AP 350 in lieu of RAN 310. CRCC 330 can operate in a non-near real-time regime. Moreover, CRMC 340 can operate in a near real-time regime.

CRCC 330 can be employed to monitor network conditions, via monitoring component 332, and to develop, improve, etc., ML/AI model(s), process(es), etc., via modeling component 334. ML/AI model(s), process(es), etc., can be based on monitored KPIs, e.g., real world responses can be employed to train machine learning to be more accurate. Moreover, training data, that can result from monitoring KPIs of a network, can result in a more efficient model/process. The NRT regime operation of CRRC 330 can facilitate development ongoing development of ML/AI model(s), process(es), etc., via modeling component 334 based, in part, on KPIs receive via monitoring component 332. The ML/AI model(s), process(es), etc., can then be communicated to CRMC 340, such that model update component 346 can update the ML/AI model(s), process(es), etc., being employed by analysis component 344 to predict, infer, etc., a likelihood of a network congestion event based on monitored network KPIs via monitoring component 342. It is noted that monitoring component 332 can monitor the same or different KPIs as monitoring component 342, e.g., KPIs relevant to developing and evaluating ML/AI model(s), process(es), etc., can be the same or different from KPIs relevant to determining, predicting, inferring, etc., a likelihood of a congestion event based on a ML/AI model(s), process(es), etc. As such, where a congestion event is predicted by CRMC 340, this can be indicated to CRCC 330 that can then determine signaling to UE 302 that can cause UE 302 to reroute communication through AP 350 in lieu of RAN 310. In embodiments, CRCC 330 can further indicate to UE 302 a time that to stay off RAN 310, e.g., a reconnect time, delay, etc. In embodiments, the time can be a default time, a determined time, such as can be determined based on the KPIs and predicted congestion event, an indefinite time, or other times, delays, etc. In embodiments, CRCC 330 can receive an indication that a congestion event has passed, e.g., CRCC 330 can determine resolution of a congestion event by monitoring network KPIs, CRCC 330 can receive an indication from CRMC 340 based on CRMC 340 determining that the congestion event has concluded, etc. In these embodiments, CRCC 330 can indicate to UE 302 that RAN 310 is again available for communication. In some embodiments, CRCC 330 can direct UE 302 to reconnect to RAN 310, e.g., actively triggering UE 302 to reconnect to RAN 310 rather than more passively waiting for UE to reconnect to RAN 310 once it become available.

In system 300, UE 302 can comprise congestion response reaction component (CRRC) 304. CRRC 304 can receive an indication from vRAN 312, e.g., via CRRC 330, that can correspond to an inference, prediction, determination, etc., of a likelihood of a congestion event occurring based on analysis by CRMC 340, e.g., via analysis component 344. CRRC 304 can cause UE 302, in response to the indication of the congestion event likelihood, to shift communications away from RAN 310, e.g., moving communications to AP 350 in lieu of RAN 310 to mitigate the effects of a congestion event, or, in some circumstances to reduce the likelihood of the predicted congestion event even occurring. CRRC 304 can further track any provided delay time values indicated, or revert to a default delay time, before beginning a reconnection operation to move UE 302 back to RAN 310. In an example, CRCC 330 can indicate to CRRC 304 that UE 302 should move from RAN 310 to AP 350 until p.m., such that UE 302 will not typically attempt to reconnect to RAN 310 until p.m. In another example, CRRC 304 can be instructed to wait ten minutes prior to any attempt to reconnect to RAN 310. In a still further example, CRRC 340 can received information indicating that no attempt to reconnect to RAN 310 should be made without a subsequent instruction indicating RAN 310 is again available. Numerous other examples are readily appreciated and within the scope of the disclosure even where not recited of the sake of clarity and brevity.

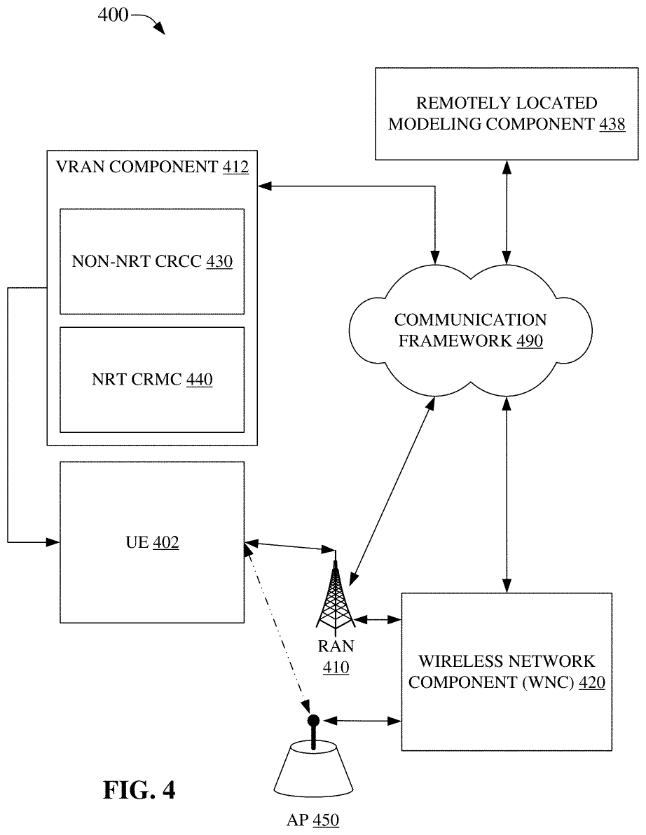

FIG. 4 is an illustration of a system 400, which can enable responding to predicted RAN congestion based on determining a model via a remotely located modeling component, in accordance with aspects of the subject disclosure. System 400 can comprise UE 402 that can be connected to a WNC 420 that is associated with a wireless network provider via RAN 410. WNC 420 can connect to other networks, devices, components, servers, etc., for example, UE 402 can communicate with internet server via RAN 410, WNC 420, and communication framework 490. System 400 can further comprise AP 450 that can be coupled to WNC 420. As an example, AP 450 can be a WI-FI AP that can connect UE 402 to WNC 420 to facilitate communication between UE 402 and other devices, components, etc., through communication framework 490, e.g., UE 402 can reach an internet server via AP 450, WNC 420, and communication framework 490.

System 400 can comprise non-NRT CRCC 430 and NRT CRMC 440. It is noted that non-NRT CRCC 430 can be the same as, or similar to CRCC 130, and can explicitly operate in a non-NRT regime. Similarly, NRT CRMC 440 can be the same as, or similar to CRMC 140, and can explicitly operate in the NRT regime. Accordingly, for clarity and brevity, non-NRT CRCC 430 is hereinafter typically referred to simply as CRCC 430, and similarly, NRT CRMC 440 is typically referred to simply as CRMC 440. CRCC 430 and CRMC 440 can be communicatively coupled. In embodiments, virtual radio access network (vRAN) component 412 can comprise CRCC 430 and CRMC 440. A vRAN can be, for example, embodied in an O-RAN reference architecture open RAN.

In system 400, vRAN 412 can monitor wireless network KPIs, which can enable CRMC 440 access to network KPIs to facilitate predicting, inferring, etc., a likelihood of a congestion event, e.g., a threshold level of congestion, etc., at RAN 410. In system 400 monitoring is illustrated as occurring via communication framework 490, e.g., vRAN 412 need not be local to RAN 410, WNC 420, etc., but instead can be implemented as a remotely located component, virtual component such as an instance executing of a server of a cloud system, etc. CRMC 440 can employ a ML/AI process(es), model(s), or combination thereof, to determine an occurrence of a threshold level of network congestion. It is noted that the congestion can occur anywhere in the network and shedding UEs from an affected RAN can mitigate the impact of a congestion event on a customer experience, e.g., steering UE 402 away from RAN 410 where a congestion event is predicted to occur can typically mitigate or avoid the congestion event affecting communications between UE 402 and WNC 420. It is noted that the act of steering traffic away from RAN 410 itself can mitigate the occurrence of the predicted congestion event. It is further noted that the predicted congestion event can still occur despite steering traffic away. In some embodiments, a predicted, inferred, etc., network congestion event can relate to network circumstances beyond the connection between UE 402 and WNC 420, e.g., a core network component can experience a failure, high latency can occur in communication framework 490, etc. In these embodiments, CRMC 440 can still infer, predict, etc., a likelihood of a congestion event. Moreover, in these embodiments, rerouting of UE 402 from RAN 410 to AP 450 for example, can be more similar to rerouting UE 502 in system 500 to decoupled AP 554 that can bypass WNC 520 in an attempt to avoid impacts of the predicted congestion event.

CRCC 430 can be employed to monitor network conditions and to develop, improve, etc., ML/AI model(s), process(es), etc., e.g., via modeling component 334, etc. ML/AI model(s), process(es), etc., can be based on monitored KPIs, e.g., real world responses can be employed to train machine learning to be more accurate. Moreover, training data, that can result from monitoring KPIs of a network, can result in a more efficient model/process. In an embodiment, ML/AI model(s), process(es), etc., refinement, development, updating, etc., can be supplemented by processing that can be performed via remotely located modeling component 438. In these embodiments, remotely located modeling component 438 can enable application of computing resources towards development, improvement, updating, etc., of ML/AI model(s), process(es), etc., that can exceed the computing resources of CRCC 430 for example. In some embodiments, remotely located modeling component 438 can be employed in lieu of a modeling component 334, etc., e.g., remotely located modeling component 438 can supply all computing resources dedicated to development, improvement, updating, etc., of ML/AI model(s), process(es), etc., on behalf of CRCC 430. In these embodiments, KPI monitoring can be adapted to streamline access to KPIs as part of development, improvement, updating, etc., of ML/AI model(s), process(es), etc., by remotely located modeling component 438. Similarly, in these embodiments, ML/AI model(s), process(es), etc., from remotely located modeling component 438 can be communicated to CRMC 440 via a more streamlined communication process, e.g., via communication framework 490 on behalf of CRCC 430. However, more typically, a ML/AI model(s), process(es), etc., will generally be communicated from CRCC 430 to CRMC 440 in a manner disclosed elsewhere herein at length.

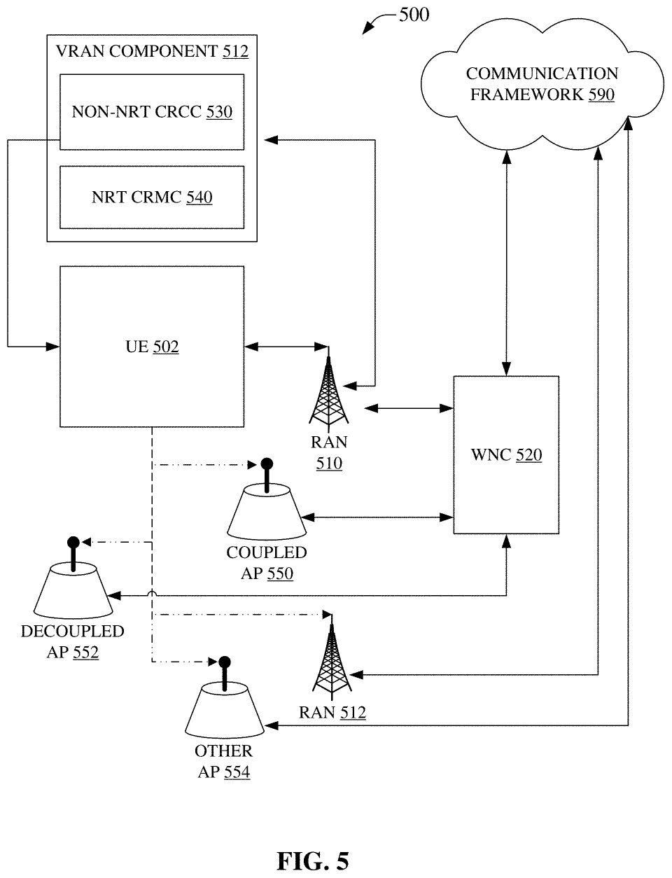

FIG. 5 is an illustration of an example system 500 that can facilitate responding to predicted RAN congestion supporting routing traffic via one or more of a RAN, a coupled AP, a decoupled AP, or a component bypassing a core network, in accordance with aspects of the subject disclosure. System 500 can again comprise UE 502 that can be connected to a WNC 520 that is associated with a wireless network provider via RAN 510. WNC 520 can connect to other networks, devices, components, servers, etc., for example, UE 502 can communicate with internet server via RAN 510, WNC 520, and communication framework 590. System 500 can further comprise AP 550 that can be coupled to WNC 520. As an example, AP 550 can be a WI-FI AP that can connect UE 502 to WNC 520 to facilitate communication between UE 502 and other devices, components, etc., through communication framework 590, e.g., UE 502 can reach an internet server via AP 550, WNC 520, and communication framework 590.

System 500 can comprise non-NRT CRCC 530 and NRT CRMC 540. It is noted that non-NRT CRCC 530 can be the same as, or similar to CRCC 130, and can explicitly operate in a non-NRT regime. Similarly, NRT CRMC 540 can be the same as, or similar to CRMC 140, and can explicitly operate in the NRT regime. Accordingly, for clarity and brevity, non-NRT CRCC 530 is hereinafter typically referred to simply as CRCC 530, and similarly, NRT CRMC 540 is typically referred to simply as CRMC 540. CRCC 530 and CRMC 540 can be communicatively coupled. In embodiments, virtual radio access network (vRAN) component 512 can comprise CRCC 530 and CRMC 540. A vRAN can be, for example, embodied in an O-RAN reference architecture open RAN.

In system 500, vRAN 512 can monitor wireless network KPIs, which can enable CRMC 540 access to network KPIs to facilitate predicting, inferring, etc., a likelihood of a congestion event, e.g., a threshold level of congestion, etc., relative to RAN 510. CRMC 540 can employ a ML/AI process(es), model(s), or combination thereof, to predict, infer, determine, etc., an occurrence of a threshold level of network congestion, e.g., CRMC 540 can predict a likelihood of a congestion event based on model(s), process(es), or combinations thereof, and monitored KPIs for a portion of a network. CRMC 540 can receive an updated model, process, etc., e.g., from CRCC 530, etc. It is noted that the predicted congestion can occur in any portion of a network and shedding UEs from a RAN expected to be affected by a predicted, inferred, etc., congestion event can mitigate the impact of a congestion event on a customer experience, e.g., steering UE 502 away from RAN 510 where a congestion event is predicted to affect RAN 510 can typically mitigate or avoid the congestion event affecting communications between UE 502 and WNC 520.

In an embodiment, steering traffic away from RAN 510 can be directed to selected alternate devices or network components. As an example, an AP can be associated with a network carrier identity or network provider identity that can also be associated with operation of MNC 520. Additional APs can be associated with other entities than the network carrier or provider identity. Furthermore, an alternat RAN can be unaffiliated with a network carrier or provider identity. In this regard, coupled AP 550 can illustrate an AP affiliate with a carrier identity also affiliated with WNC 520, decoupled AP 552 can be affiliated with a different carrier identity than can be affiliated with WNC 520. Similarly, RAN 512 can be unaffiliated with a carrier identity for WNC 520. Moreover, other AP 554 can be either affiliated or unaffiliated with a carrier identity affiliated with MNC 520 and, like RAN 512, can support bypassing WNC 520. In an embodiment, shifting UE away from RAN 510 can then be directed to determine network access resource, for example, selected from among the group comprising coupled AP 550, decoupled AP 552, RAN 512, and other AP 554. It is noted that selection of a determined network access resource can be ordered, for example to preferrable select a resource affiliated with a carrier identity associated with WNC 520 before other resources. In an example, where carrier XYZ operates WNC 520 and coupled AP 550, but not decoupled AP 552, the carrier can prefer that UE 502 be shifted to coupled AP 550 over decoupled AP 552 because it can enable carrier XYZ to provide contracted services without involving non-carrier recourse, etc. It is further noted that shifting to either coupled AP 550 or decoupled AP 552 can still result in traffic being communicated via WNC 520. However, where WNC 520 can be predicted to be affected by a congestion event, it can be desirable to route traffic around WNC 520. In this regard, an embodiment can enable shifting UE 502 from RAN 510 to either RAN 512 or other AP 554, which, as has been noted, can be affiliated or unaffiliated with a carrier identity associated with WNC 520. As is illustrated, shifting from RAN 510 to RAN 512 or other AP 554 can result in bypassing WNC 520. This can be beneficial in mitigating effects from a predicted congestion event. It is noted that, similar to ordering between affiliated an unaffiliated network access resources that do not bypass WNC 520, selection preference between affiliate and unaffiliated network access resources that do bypass WNC 520 can similarly be ordered, ranked, etc. As an example, where RAN 512 is affiliated with a carrier identity associated with WNC 520, this RAN can be preferential to other AP 540 that can be unaffiliated with the carrier identity.

CRMC 540 can indicate to CRCC 530 a likelihood of a congestion event. As such, CNCC 530 can employ the indicated likelihood in determining signaling to UE 502. As an example, in response to CRMC 540 indicating a high probability of an upcoming congestion event, signaling component 536 of CNCC 530 can generate a signal that can indicate to UE 502 that it should route communications, e.g., data, voice, or combinations thereof, via one or more of coupled AP 550, decoupled AP 552, other AP 554, RAN 512, etc., in lieu of RAN 510. The preferential order of these other communication resources can be indicated by CRCC 530. It is again noted that CRCC 530 can operate in a non-near real-time regime and that CRMC 540 can operate in a near real-time regime.

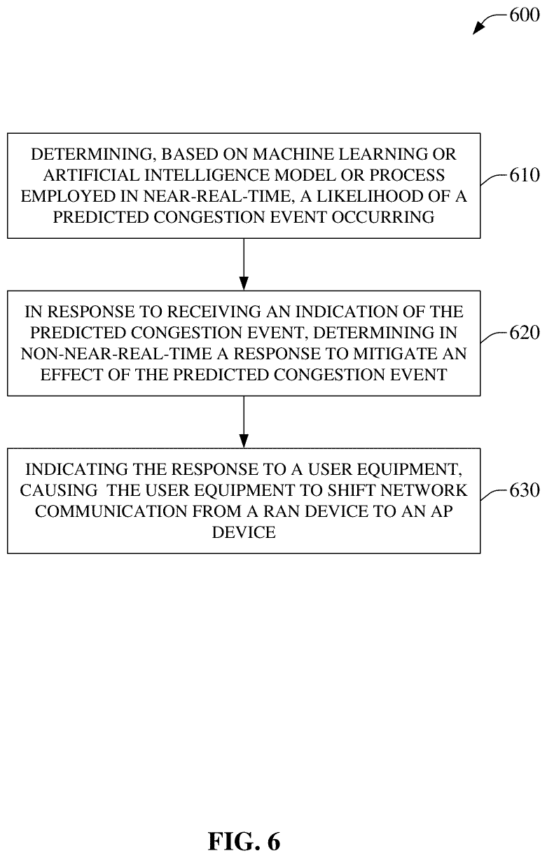

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternately be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 is an illustration of an example method 600 facilitating responding to predicted RAN congestion, in accordance with aspects of the subject disclosure. Method 600, at 610, can comprise determining a likelihood of a predicted congestion event occurring. The determining can be based on a ML/AI model or process that can be employed in a near-real-time (NRT) regime, for example with delays of between about ten milliseconds and one second, where a real-time regime can then be associated with processing delays of less than about 10 milliseconds, and where a non-NRT regime correspondingly can be delays typically not less than one second. In an example embodiment, the determining can be performed via a near-real-time radio interface controller (NRT RIC) of an O-RAN type vRAN. Determining in NRT can differ from determinations made in non-NRT in that lower priority operations can generally be relegated to slower/more delayed processing, e.g., in a non-NRT regime, while higher priority operations, comparatively, can generally be performed with more urgency/less delay, e.g., in a NRT regime. At 610, predicting congestion can be considered a higher priority operation than perhaps immediately notifying UEs of expected congestion, computing a more accurate or efficient model/process, etc. Accordingly, the NRT regime operations can be pared down to those operations most directly related to predicting congestion based on previously determined models/processes. Similarly, mitigation, e.g., notification of appropriate devices to take appropriate determined actions, can be relegated to non-NRT regime operations.

As such, method 600, at 620, can comprise determining in non-near-real-time (non-NRT) a response to mitigate an effect of the predicted congestion event. The determining can be triggered in response to receiving an indication of the predicted congestion event, which can comprise information about predicted parameters of an expected congestion event. As an example, a cellular tower near an elementary school can typically experience increased load Monday to Friday near 9 a.m. and 3 p.m., e.g., when parents can be dropping off or picking up their children. In this example, ML/AI can predict in NRT a congestion event will occur in the noted time windows. Moreover, the ML/AI can predict in NRT that the congestion typically can last, for example, only about 30 minutes. This information can be indicated to trigger determining, in non-NRT, a mitigation response that can direct UEs that have been near the school outside the window, e.g., school faculty/staff/vendors, to shift to an AP in lieu of the cell tower. This can have the effect of unburdening the cell tower to allow approaching UEs room to park on the network via the cell tower, e.g., moving faculty/staff/vendors to an AP can make room for parent's UEs to use the tower in this example.

At 630, method 600 can comprise indicating the response determined at 620 to a UE. At this point, method 600 can end. In it noted that the UE can be caused to shift from a RAN to an AP device based on receiving the indication. In some embodiments, native UE operations can support receiving indications that can cause the UE to release the example RAN and park on the network via the AP. In other embodiments, a UE execute non-native operations, e.g., running an application, widget, etc., that can support shifting from the RAN to the AP in response to receiving an indication of the projected congestion event.

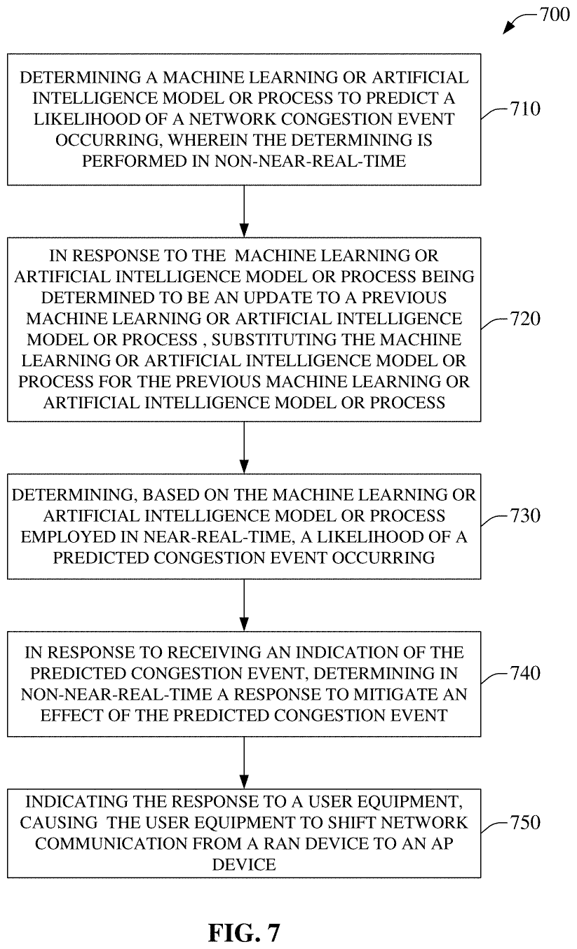

FIG. 7 illustrates example method 700 facilitating updating a model employed in responding to predicted RAN congestion, in accordance with aspects of the subject disclosure. Method 700, at 710, can comprise determining a ML/AI model or process to predict a likelihood of a network congestion event occurring. The determining of the ML/AI model or process can be performed in non-near-real-time, rather than in NRT or RT, e.g., the determining the ML/AI model or process can be relegated to slower or more delayed computing resources due to a new ML/AI model or process typically being lower priority than employing an already existing ML/AI model or process to predict a possible congestion event.

The ML/AI model or process determined at 710 can, at 720, replace a pre-existing ML/AI model or process. Where a pre-existing ML/AI model or process is determined to be present, the ML/AI model or process can be substituted for the pre-existing ML/AI model or process. As such, method 700 can support updating of an ML/AI model or process. Further, where there is not a pre-existing ML/AI model or process, the ML/AI model or process determined at 710 can be used as a first ML/AI model or process that can later be updated in subsequent iterations of method 700. Moreover, the ML/AI model or process can be determined in a non-NRT regime but can be used in a NRT regime, which can avoid burdening NRT computing resources with operations that are not directly replated with determining a likelihood of a congestion event occurring and related parameters, e.g., predicted length, severity, area of effect, etc., of a predicted, inferred, etc., congestion event.

At 730, method 700 can comprise determining a likelihood of a predicted congestion event occurring. The determining can be based on the ML/AI model or process determined in non-NRT, that can be performed in NRT. As has been noted, it can be preferred to use of a determined ML/AI model or process to predict an occurrence of congestion in the network in NRT to provide an indication early which can result in having reasonable time for determining a mitigation response without directly encumbering the NRT RIC with the mitigation response determination operations, e.g., prompt/early determining of an upcoming congestion event can allow slower computing resources time to determine a mitigation strategy. Generally, it can be appreciated that predicting an event in non-NRT may not leave sufficient time to determining a mitigation response, while predicting an event and also determining a response in NRT generally can be considered wasteful of typically limited NRT computing resources. Similarly, while it can be possible to predict a congestion event in a RT regime, this can be considered wasteful of typically even more limited RT computing resources and, as such, would probably not be favored in the industry at the present time and present level of technology. In an example embodiment, the determining can be performed via a NRT RIC of a vRAN.

As such, method 700, at 740, can comprise determining, again returning to a non-NRT regime, a response to mitigate an effect of the predicted congestion event. The determining can be triggered in response to receiving an indication of the predicted congestion event, which can comprise information about predicted parameters of an expected congestion event. The predicted parameters of the expected congestion event can enable determining features of a mitigation response, such as indicating a delay time, selecting affected UEs, strategizing around the effects of moving selectable UEs to designatable APs, etc. Returning to the elementary school example, e.g., as discussed in method 600, where the congestion is relatively minor, a strategy to move teachers/staff/vendors to APs can be determined to be sufficiently responsive to the predicted congestion event, however, where the congestion is predicted to be substantial, for example due to scheduled maintenance of other nearly cell towers, then another strategy to move staff/teachers/vendors and additionally notify previously observed parental UEs that they should switch to an AP when arriving at the school can be determined to be favorable to other mitigation strategies.

At 750, method 700 can comprise indicating the response determined at 740 to a UE. At this point, method 700 can end. It is noted that the UE can be caused to shift from a RAN to an AP device based on receiving the indication. In some embodiments, native UE operations can support receiving indications that can cause the UE to release the example RAN and park on the network via the AP. In other embodiments, a UE execute non-native operations, e.g., running an application, widget, etc., that can support shifting from the RAN to the AP in response to receiving an indication of the projected congestion event. Moreover, it is noted that UEs can be directed to selected APs or other RANs, which APs or other RANs can be selected based on an ordering, ranking, etc., of those network resources, e.g., a carrier operated AP can be indicated as more preferable than a non-carrier operated AP/RAN, etc.

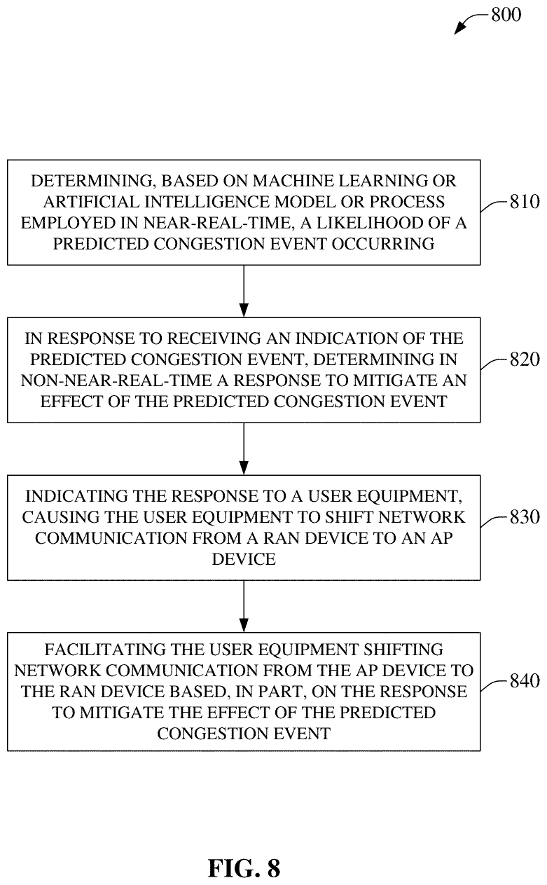

FIG. 8 illustrates example method 800, enabling returning to a RAN after responding to predicted RAN congestion, in accordance with aspects of the subject disclosure. Method 800, at 810, can comprise determining a likelihood of a predicted congestion event occurring. The determining can be based on a ML/AI model or process that can be employed in a NRT regime.

At 820, method 800 can comprise determining, in a non-NRT regime, a response to mitigate an effect of the predicted congestion event. The determining can be triggered in response to receiving an indication of the predicted congestion event, which can comprise information about predicted parameters of an expected congestion event. The predicted parameters of the expected congestion event can enable determining features of a mitigation response, such as indicating a delay time, selecting affected UEs, strategizing around the effects of moving selectable UEs to designatable APs, etc.

At 830, method 800 can comprise indicating the response determined at 820 to a UE. It is noted that the UE can be caused to shift from a RAN to an AP device based on receiving the indication. In some embodiments, native UE operations can support receiving indications that can cause the UE to release the example RAN and park on the network via the AP. In other embodiments, a UE execute non-native operations, e.g., running an application, widget, etc., that can support shifting from the RAN to the AP in response to receiving an indication of the projected congestion event.

Method 800, at 840, can comprise facilitating the UE to shift network communication from the AP device back to the RAN device. At this point, method 800 can end. The return of the UE to the RAN from the AP can be, in part, based on the response to mitigate the effect of the predicted congestion event. As is noted hereinabove, the predicted parameters of the expected congestion event can enable determining features of a mitigation response, such as indicating a delay time. The delay time can be related to a predicted duration of the expected congestion event, e.g., the perdition of the congestion event occurring can include a prediction on how long the congestion can endure. Where the carrier can desire the UE to camp on carrier related network resources, e.g., to better provide the services of the carrier to the customer, etc., it can be desirable to return the UE to the RAN after the congestion is expected to have passed, ben resolved, etc. In embodiments, a duration can be indicated, a specific time/date can be indicated, a default time/duration can be indicated, a checkback interval can be indicated, etc. Returning go the elementary school example, see method 600, where the expected duration of the congestion is 30 minutes, method 800 can facilitate the UE shifting back to the RAN from the AP after 30 minutes, e.g., the predicted duration can be indicated to the UE at 830, etc.

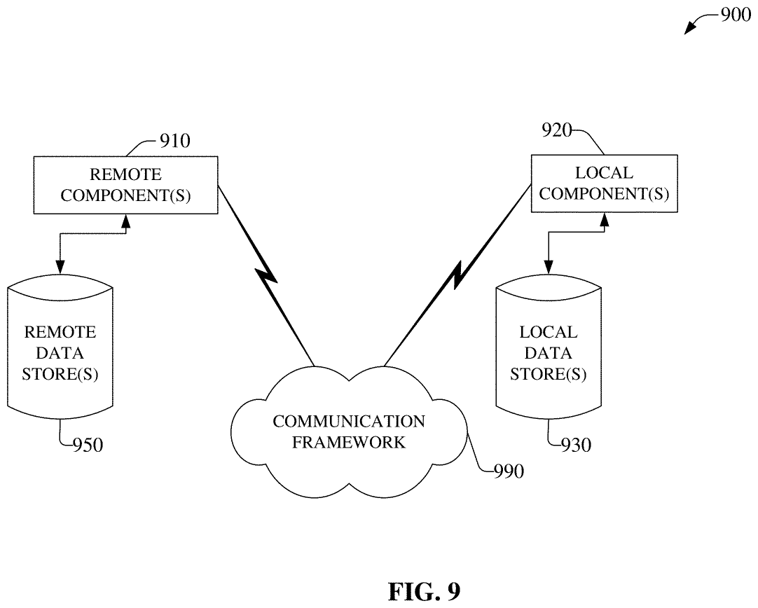

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can comprise one or more of CRCC 130-530, etc., CRMC 140-540, etc., RAN 110-510, 512, etc., AP 150-550, 552, 554, etc., UE 102-502, etc., WNC 120-520, etc., or other components supporting the technology(s) disclosed herein. As an example, CRMC 140 can be located remotely from a local CRCC 130.

The system 900 also comprises one or more local component(s) 920. The local component(s) 920 can be hardware and/or software (e.g., threads, processes, computing devices). In some embodiments, local component(s) 920 can comprise one or more of CRCC 130-530, etc., CRMC 140-540, etc., RAN 110-510, 512, etc., AP 150-550, 552, 554, etc., UE 102-502, etc., WNC 120-520, etc., or other components supporting the technology(s) disclosed herein. As an example, CRCC 130 can be located remotely from a local CRMC 140.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 990 that can be employed to facilitate communications between the remote component(s) 910 and the local component(s) 920, and can comprise an air interface, e.g., Uu interface of a UMTS network, via a long-term evolution (LTE) network, etc. As an example, CRMC 140 can generate an indication of a likelihood of a congestion event occurring that can be communicated to a remotely located CRCC 130, or other remotely located components, via communication framework 190, 990, etc., or other communication framework equipment, to facilitate determining a mitigation response that can be indicated to UE 102, wherein UE 102 can be located remotely from CRMC 140, CRCC 130, etc. Remote component(s) 910 can be operably connected to one or more remote data store(s) 950, such as a hard drive, solid state drive, SIM card, device memory, etc., that can be employed to store information on the remote component(s) 910 side of communication framework 990.

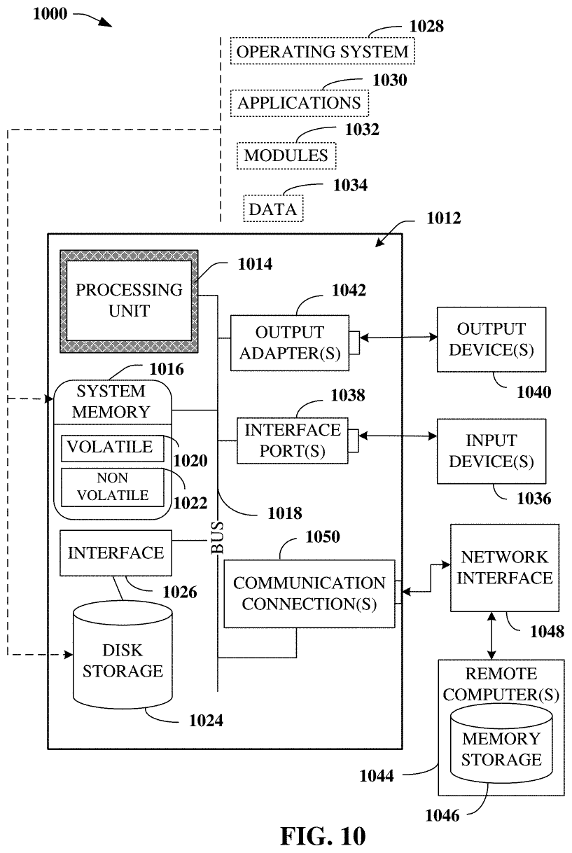

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), single board computers, microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, comprised in vRAN 212-512, CRCC 130-530, etc., CRMC 140-540, etc., RAN 110-510, 512, etc., AP 150-550, 552, 554, etc., UE 102-502, etc., WNC 120-520, etc., or other components supporting the technology(s) disclosed herein, can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows. It is noted that machines comprising a computing device can similarly comprise media, in which embodiments, the term ‘computer-readable’ can be substituted with the term ‘machine-readable,’ e.g., a computing device can perform operations stored on computer readable media while a machine that can perform a computation can perform operations stored on machine-readable media. In embodiments of a machine comprising a computing device, the machine can perform operations stored on computer-readable media, machine-readable media, or combinations thereof. Hereinafter, the term computer readable media is inclusive of the term machine-readable media, as would be appreciated by one of ordinary skill in the art, for the sake of brevity and clarity.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, can cause a system comprising a processor to perform operations comprising predicting a probability of an occurrence of a network congestion event via artificial intelligence, and based on a key performance indicator applicable to a network, wherein the network comprises a wireless radio access network node and a wireless access point node, wherein the predicting occurs in a defined near-real-time that causes near-real-time operations to be performed with less than a first delay, and wherein the first delay is at least an order of magnitude less than a second delay corresponding to performance of non-real-time operations in a defined non-real-time; and in response to receiving first information corresponding to the probability of the occurrence of the congestion event, communicating, to a user equipment, second information comprised in a mitigation strategy based on the first information, wherein the mitigation strategy is determined in the defined non-real-time via the non-real-time operations, and wherein the information comprised in the mitigation strategy causes a user equipment to truncate, for a specified period, communication via the wireless radio access network node in favor of communicating via the wireless access point node.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command-line controlled interface, etc., allowing a user to interact with computer 1012. Input devices 1036 comprise, but are not limited to, a pointing device such as a mouse, trackball, stylus, touch pad, keyboard, microphone or other human voice sensor, accelerometer, biomentric sensor, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial bus port can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted elsewhere herein, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “eNodeB,” “home Node B,” “home access point,” “5G network radio,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can comprise packetized or frame-based flows. Data or signal information exchange can comprise technology, such as, single user (SU) multiple-input and multiple-output (MIMO) (SU MIMO) radio(s), multiple user (MU) MIMO (MU MIMO) radio(s), long-term evolution (LTE), LTE time-division duplexing (TDD), global system for mobile communications (GSM), GSM EDGE Radio Access Network (GERAN), Wi Fi, WLAN, WiMax, CDMA2000, LTE new radio-access technology (LTE-NX), massive MIMO systems, etc.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio access network. Authentication can refer to authenticating a user-identity to a user-account. Authentication can, in some embodiments, refer to determining whether a user-identity requesting a service from a telecom network is authorized to do so within the network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to as extremely high frequency (EHF) waves. The wavelength (λ) for millimeter waves is typically in the 1-mm to 10-mm range.

The term “infer” or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A device, comprising:
a processor; and
a memory that stores executable instructions that, when executed by the processor, facilitate performance of operations comprising:
determining a likelihood of a network congestion event occurring based on a key performance indicator of a network comprising a radio access network node and a access point node, wherein determining the likelihood is performed with less than a first delay, and wherein the first delay is at least an order of magnitude less than a second delay;
in response to receiving an indication of the likelihood of the congestion event occurring, determining a mitigation strategy, wherein determining the mitigation strategy is performed with less than the second delay; and
indicating to a user equipment, based on the mitigation strategy, information instructing the user equipment to shift communication via the network from employing the radio access network node to employing the access point node.

2. The device of claim 1, wherein the processor is a first processor, wherein determining the likelihood of the network congestion event occurring is performed via the first processor in a defined near-real-time regime associated with the first delay, and wherein the determining the mitigation strategy is performed via a second processor in a defined non-near-real-time regime associated with the second delay.

3. The device of claim 2, wherein the defined near-real-time regime is associated with delays less than one second.

4. The device of claim 3, wherein the defined near-real-time regime is associated with delays longer than ten milliseconds.

5. The device of claim 2, wherein the first processor and the second processor are deployed according to a virtual radio access network architecture.

6. The device of claim 5, wherein the virtual radio access network architecture is an O-RAN ALLIANCE reference architecture, wherein the first processor is embodied in a near-real-time radio-interface-controller according to the O-RAN ALLIANCE reference architecture, and wherein the second processor is embodied in a non-real-time radio-interface-controller according to the O-RAN ALLIANCE reference architecture.

7. The device of claim 1, wherein determining the likelihood of the network congestion event occurring based on the key performance indicator of the network comprises executing an operation based on a machine learning or artificial intelligence model.

8. The device of claim 7, wherein the machine learning or artificial intelligence model or process is updateable based on a subsequently determined machine learning or artificial intelligence model or process.

9. The device of claim 8, wherein the subsequently determined machine learning or artificial intelligence model or process is determined via operations occurring with less than the second delay.

10. The device of claim 1, wherein the indicating comprises indicating information indicating a predicted duration of the network congestion event, and wherein the indicating instructs the user equipment, after the predicted duration, to shift the communication via the network from employing the access point node to employing the radio access network node.

11. The device of claim 10, wherein the predicted duration is specified as a certain time and date.

12. The device of claim 10, wherein predicted duration is specified as a certain period of time.

13. The device of claim 10, wherein predicted duration is defined as a duration until further information is communicated to the user equipment to instruct the user equipment, after the further information is received by the user equipment, to shift the communication via the network from employing the access point node to employing the radio access network node.

14. A method, comprising:
determining, by a system comprising a processor, a likelihood of a network congestion event occurring based on a key performance indicator associated with a network and machine learning, wherein the network comprises a radio access network node and an access point node, wherein determining the likelihood is performed within a first defined amount time corresponding to near-real-time, and wherein determining the likelihood within the first defined amount of time experiences first delays in performing operations that are at least an order of magnitude less than second delays of performing the operations within a second defined amount of time corresponding to non-real-time;
in response to receiving, by the system, information corresponding to the likelihood of the congestion event occurring, determining, within the second defined amount of time, a mitigation scheme; and
instructing, by the system based on the mitigation scheme, a user equipment to avoid communicating via the radio access network node until a determined time, wherein the instructing results in the user equipment communicating via the access point node in lieu of the communicating via the radio access network node.

15. The method of claim 14, wherein the machine learning comprises a machine learning or artificial intelligence model or process, and wherein the machine learning or artificial intelligence model or process is updateable based on another machine learning or artificial intelligence model or process determined by operations performed within the second defined amount of time.

16. The method of claim 14, wherein the access point node is a first access point node, wherein the network comprises at least a second access point node, and wherein the first access point node is preferentially selected over the second access point node based on a first carrier identity affiliated with the first access point node being a different carrier identity than a second carrier identity affiliated with the second access point node.

17. The method of claim 14, wherein determining the likelihood of the network congestion event occurring and determining the mitigation scheme are executed in accordance with a virtual radio access network architecture comprising a near-real-time radio-interface-controller and a non-real-time radio-interface-controller.

18. A non-transitory machine-readable medium, comprising executable instructions that, when executed by a processor of equipment, facilitates performance of operations, comprising:
predicting a probability of an occurrence of a network congestion event via artificial intelligence, and based on a key performance indicator applicable to a network, wherein the network comprises a wireless radio access network node and a wireless access point node, wherein the predicting occurs in a defined near-real-time that causes near-real-time operations to be performed with less than a first delay, and wherein the first delay is at least an order of magnitude less than a second delay corresponding to performance of non-real-time operations in a defined non-real-time; and
in response to receiving first information corresponding to the probability of the occurrence of the congestion event, communicating, to a user equipment, second information comprised in a mitigation strategy based on the first information, wherein the mitigation strategy is determined in the defined non-real-time via the non-real-time operations, and wherein the information comprised in the mitigation strategy causes a user equipment to truncate, for a specified period, communication via the wireless radio access network node in favor of communicating via the wireless access point node.

19. The non-transitory machine-readable medium of claim 18, wherein the artificial intelligence comprises a machine learning or artificial intelligence model or process that is updateable based on another machine learning or artificial intelligence model or process determined by performance of the non-real-time operations.

20. The non-transitory machine-readable medium of claim 18, wherein the wireless radio access network node and the wireless access point node are preferably affiliated with a same network provider identity.
